(19) United States
(12) Patent Application Publication
(10) Pub. No.: US 2018/0306227 A1
(43) Pub. Date: Oct. 25, 2018

(54) A STRONG SELF-DRILLING RIVET WITH AN EJECTABLE DRILL ELEMENT

(71) Applicant: A. RAYMOND ET CIE, Grenoble (FR)

(72) Inventors: Mathieu COCHARD, Proveysieux (FR); Jonathan FENOLL, Seyssinet (FR); Yves-Marie DEPAIL, Grenoble (FR)

(21) Appl. No.: 15/771,866

(22) PCT Filed: Oct. 25, 2016
(86) PCT No.: PCT/FR2016/052770

§ 371 Date: Apr. 27, 2018

(30) Foreign Application Priority Data
Oct. 27, 2015 (FR) 1560258

(51) Int. Cl. F16B 19/08

(52) U.S. Cl. CPC F16B 19/083

(57) ABSTRACT

A self-drilling rivet (1) is provided. The self-drilling rivet comprises a bearing collar (3) and an expandable hollow tubular body (2), the body (2) having, at one end, a first cylindrical portion (5) adjacent to the collar (3), and at the other end of the body (2), a second cylindrical portion (6) arranged to receive a drill element (4), and between the cylindrical first and second portions (5, 6), a third portion (7) that is expandable. The third portion (7) of the body (2) and the drill element (4) have respective connection means (11, 15) that are arranged so as to separate the drill element (4) from the body (2) during expansion of the third portion (7) of the body (2).

THIS APPLICATION IS A 371 NATIONAL PHASE ENTRY OF PCT/FR2016/052770, FILED 25 OCT. 2016, WHICH CLAIMS BENEFIT OF FRENCH PATENT APPLICATION NO. 1560258, FILED 27 OCT. 2015, THE ENTIRE CONTENTS OF WHICH ARE INCORPORATED HEREIN BY REFERENCE FOR ALL PURPOSES.

### TECHNICAL FIELD

The invention relates to a self-drilling rivet comprising a bearing collar and an expandable hollow tubular body, the body having, at one end, a first cylindrical portion adjacent to the collar, and at the other end of the body, a second cylindrical portion arranged to receive a drill element, and between the cylindrical first and second portions, a third portion that is expandable.

### RELATED ART

It is known to use a self-drilling expandable anchor bolt for assembling together, in simple manner, two elements such as a part and a support.

Documents FR 2 927 382 and FR 2 992 698 describe self-drilling anchor bolts, each having a head in the form of a collar, a drilling end, and a bolt body extending between the collar and the drilling end. The bolt body has a tapped portion suitable for co-operating with the thread of a screw. Nevertheless, in the automobile industry, those types of self-drilling anchor bolts do not satisfy manufacturers since after the drilling and assembly operation, the projecting drill end can injure an operator handling the elements that have been fastened together.

Furthermore, the drill ends of self-drilling anchor bolts increases the size of those anchor bolts once they are fastened to the elements for fastening together.

Documents US 2015/0043995 and CA 2 080 065 describe self-drilling anchor bolts, each having a drill end that can be removed manually by an operator after a drilling and assembly operation. Manually removing the drill end can be difficult when it is not visible or when access thereto is difficult after assembly, so those self-drilling anchor bolts do not make it possible to improve the rate at which elements are assembled in a motor vehicle.

Furthermore, the self-drilling anchor bolts that are presently in use, generally present a bolt body with orifices at both ends. Those orifices prevent sealing being established between one side and the other of elements for assembly that have been assembled together by prior art self-drilling anchor bolts.

Furthermore, when they are used for drilling composite elements, self-drilling anchor bolts do not enable “clean” holes to be drilled, since during drilling they often lead to delamination and to fibers being torn out, and they also give off dust in uncontrolled manner. Manufacturers thus also seek to avoid depositing dust or drilling debris while assembling two elements together.

Finally, manufacturers are still seeking to use self-drilling anchor bolts that present better shear strength and better tear-out strength.

### SUMMARY

The object of the invention is to propose a self-drilling rivet that is more compact, that is not “aggressive”, that limits the amount of residue given off during drilling, and that nevertheless remains compatible with the constraints of the automobile industry for assembling two elements together.

More particularly, the invention provides a self-drilling rivet comprising a bearing collar and an expandable hollow tubular body, the body having, at one end, a first cylindrical portion adjacent to the collar, and at the other end of the body, a second cylindrical portion arranged to receive a drill element, and between the cylindrical first and second portions, a third portion that is expandable, the rivet being characterized in that the third portion of the body and the drill element have respective connection means that are arranged so as to separate the drill element from the body during expansion of the third portion of the body.

The self-drilling rivet of the invention may also present the following features:

the hollow tubular body may present a solid axial wall;

the body may present an end wall on the cylindrical second portion;

the cylindrical second portion may have an inside thread;

the expandable third portion may be arranged to deform radially when the internally-threaded cylindrical second portion is driven in axial translation towards the collar by traction;

the cylindrical second portion may be arranged to receive a cylindrical rod extending axially in the body;

the rod may have, at one end, a first portion that extends in the first portion of the hollow body and that projects beyond the collar outside the body;

the rod may have, at its other end, a second portion arranged to be received in the second portion of the body, the second portion of the rod presenting a shoulder for co-operating with a narrowing of section of the second portion of the body so as to be prevented from moving axially in the body;

the expandable third portion of the body may be arranged to deform radially when the first portion of the rod is driven in axial translation by traction;

the rod may have a third portion between the first and second portions of the rod and include a breakable zone, the third portion of the rod being arranged so that a fraction of the third portion of the rod is inserted in the first portion of the body when the third portion of the body is fully expanded radially;

the fraction of the third portion of the rod may be defined by the breakable zone arranged flush with the collar when the third portion of the body is fully expanded radially;

the drill element may be in the form of a hollow cylinder for being fitted via a first end on the cylindrical second portion of the body;

the second portion of the body may present flats for preventing the drill element from turning relative to the body when the drill element is fitted on the body;

the drill element may present at a second end a drill tool in the form of a crown saw;

the hollow cylinder of the drill element may present edges projecting towards the inside of the hollow cylinder between the first end and the second end of the drill element in order to block the engagement of the hollow cylinder on the cylindrical second portion of the body;

the drill element may present second connection means for connecting to the body;

the second connection means for connecting the drill element to the body may be in the form of flexible tabs extending axially beyond the first end;

the flexible tabs of the drill element may have outside surfaces that are abrasive;

the expandable third portion of the body may present first connection means for connecting to the drill element;

the second connection means for connecting the expandable first portion of the body with the drill element may be in the form of notches arranged to receive the flexible tabs of the drill element;

the rivet may be made of rolled and welded sheet metal; and

the rivet may be made of die-stamped sheet metal.

With the self-drilling rivet of the invention, it is possible, quickly and easily, to assemble together two plates or a part and a support. The plates may also be car floor mats.

With this arrangement of the invention, it is possible to obtain a fastening that is compact and a rivet structure that is less dangerous for an operator.

After the elements for assembling together have been drilled by rotating the rivet by means of a screw-driver tool co-operating with the threaded portion or with the projecting rod, the collar comes to bear against the upper element for assembling, and then traction in axial translation on the tool drives radial expansion of the body, while simultaneously automatically ejecting the drill element from the body since it is pushed off by the deformation of the third portion of the rivet body.

Ejecting the drill element enables an operator to continue working without any risk of injury from the drill tool, and it also reduces the space occupied by the rivet.

Two elements are assembled together by performing the steps of drilling and anchoring the self-drilling rivet through the two plates, and this can be done quickly and in simple manner since it is performed in a single operation when using an appropriate screwing and traction tool.

Furthermore, the arrangement of the drill element, with the abrasive zone and the hollow cylinder, makes it possible both to drill holes that are “clean” and also to contain within the drill element the drilling debris and the dust that are given off. Thus, a material is ejected from the rivet body in the form of a “lump” together with the drill element.

The rivet body with the threaded portion having an end wall and a solid wall, or else a rod fraction, serves to provide sealing from one side to the other of the assembled-together elements.

After applying traction to the rod, a fraction of the third portion of the rod remains blocked in part inside the first portion of the body adjacent to the collar, thereby completely filling the first portion of the rivet body so as to reinforce the structure of the expanded rivet. Additional and calibrated axial traction applied to the rod leads to the rod breaking in the breakable zone such that the broken rod does not project beyond the collar, and comes flush with the collar.

The sheet metal rivet with the expanded body including the rod fraction provides great tear-out strength and shear strength, satisfying the constraints of the automobile industry.

### BRIEF SUMMARY OF THE DRAWINGS

The present invention can be better understood and other advantages appear on reading the following description and the accompanying drawings, in which:

FIG. 1 is a perspective view of a self-drilling rivet in a first embodiment of the invention;

FIG. 2 is an exploded view of the FIG. 1 self-drilling rivet;

FIG. 3 is a profile view of the self-drilling rivet in the first embodiment of the invention;

FIG. 4 is an axial section view of the FIG. 3 self-drilling rivet;

FIG. 5 is an axial section view of the self-drilling rivet of the first embodiment of the invention with its body expanded radially;

FIG. 6 is a perspective view of the self-drilling rivet in a second embodiment of the invention;

FIG. 7 is an exploded view of the FIG. 6 self-drilling rivet;

FIG. 8 is a profile view of the second embodiment of the self-drilling rivet;

FIG. 9 is an axial section view of the FIG. 8 self-drilling rivet; and

FIG. 10 is an axial section view of the self-drilling rivet of the second embodiment of the invention, with its body expanded radially.

### DETAILED DESCRIPTION OF EXAMPLE EMBODIMENTS

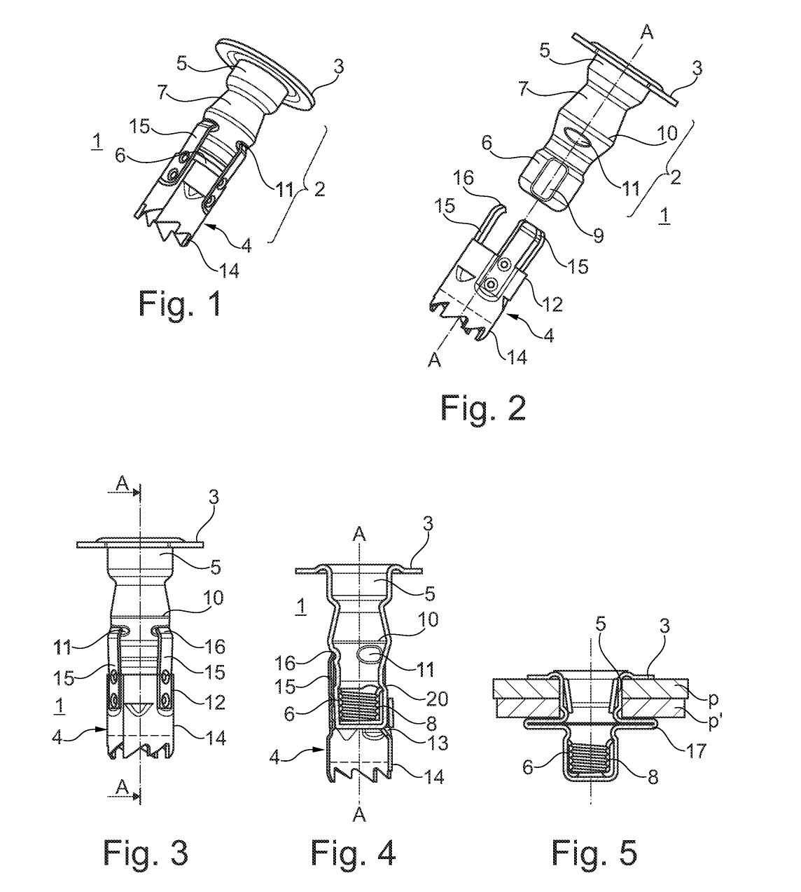

FIGS. 1 to 5 show a rivet 1 in a first embodiment of the invention for the purpose of assembling together two elements, specifically two plates (P and P′, as shown in FIG. 5). By way of non-limiting example, the plates may be made of fiberglass.

The rivet 1 comprises a tubular body 2 both with a collar 3 at one end that comes to bear, by way of example, against one of the two plates that are to be assembled together, and also with a zone (described below) at the other end of the body 2 onto which a drill element 4 is engaged as a sliding fit, which element can be seen in isolation in the exploded view of FIG. 2.

As shown in FIG. 2, the collar 3 extends in a plane perpendicular to an axis AA of the rivet 1.

The collar 3 may present teeth (not shown) that bite into the surface against which it bears in order to prevent it from rotating about the axis. The collar 3 may also have cutouts around an inlet orifice to the inside of the tubular body 2.

The tubular body 2 is hollow, being in the form of a drum or a barrel having an axial wall that is solid.

The body 2 comprises three portions extending along the axis AA: a cylindrical first portion 5 is adjacent to the collar 3, a cylindrical second portion 6 corresponding to the zone for arranging the drill element 4 as an axial sliding fit, and an intermediate third portion 7 between the two cylindrical portions 5 and 6.

The height of the cylindrical first portion 5 generally corresponds to the thickness of the plates P and P′ for assembling together.

In the first embodiment, as can be seen in FIG. 4, the cylindrical second portion 6 may be threaded internally in order to co-operate with the thread of a screw-driver tool that passes through the tubular body 2 via the orifice in the collar 3. In this example, the inside thread is on a tapped die-stamped bushing 8 that is fastened to the second portion 6 beneath a radial narrowing of section that forms a shoulder 20. The bushing 8 is fastened to the body 2 by welding or by crimping.

The outside surface of the cylindrical second portion 6 may present axially-extending flats 9, there being three flats 9 in this example, in order to facilitate fitting the drill element 4 on the second portion 6 of the rivet body 2 and in order to prevent the drill element 4 from turning relative to the rivet body 2.

The cylindrical second portion 6 of the rivet body 2 may present an end wall, as shown in FIG. 4.

In this example, the intermediate third portion 7 of the rivet body 2 is in the form of a die-stamped drum with an annular zone of weakness 10 in a middle transverse plane so that the third portion 7 of the body 2 can expand radially.

The expandable intermediate third portion 7 of the rivet body 2 presents first connection means 11 for connecting with the drill element 4. In this example, three notches projecting towards the inside of the body 2 are arranged in axial continuity with the flats 9 of the second portion 6 of the rivet body 2.

The drill element 4 is in the form of a hollow cylinder that can be fitted via a first end 12 onto the cylindrical second portion 6 of the body 2. The cylindrical inside face of the drill element 4 presents edges 13 in the form of plunged bosses that can be seen in FIG. 4 and that project towards the inside of the cylinder so as to prevent the second portion 6 of the rivet body 2 from moving axially when the drill element 4 is fitted on the cylindrical second portion 6 of the body 2.

On a second end, the drill element 4 presents a drill tool 14, specifically in the form of a circular crown saw having two stages teeth. The crown saw has an internal bore, and its teeth are distributed circumferentially around the bore so as to reduce dust generation and fiber extraction during drilling. During drilling, drilling residue thus accumulates in the hollow cylinder of the drill element 4.

Without going beyond the ambit of the invention, the second end of the drill tool 14 could be an endpiece of the drill bit type with a diamond coating (not shown).

The drill element 4 possesses second connection means 15 for connecting to the rivet body 2, and more particularly to the intermediate third portion 7 of the rivet body 2, e.g. in the form of flexible tabs extending axially beyond the first end 12 of the drill element 4.

The flexible tabs of the drill element 4 in this example present an outside surface that is abrasive, enabling the quality of drilling to be improved, with ends 16 that slope towards the inside of the drill element 4.

Prior to use, the drill element 4 of the self-drilling rivet 1 needs to be mounted on the body 2 of the rivet 1. For that purpose, while the drill element 4 is being axially fitted on the body 2 of the rivet 1, the flexible tabs splay apart on coming into contact with the second portion 6, and they slide along the flat 9 of the second portion 6 of the body 2 of the rivet 1. Thereafter, the cylindrical second portion 6 penetrates axially into the hollow cylinder of the drill element 4 until the sloping ends 16 of the flexible tabs are received in the notches of the expandable third portion 7 of the body 2 of the rivet 1. The body 2 of the rivet 1 is prevented from moving axially in the hollow cylinder of the drill element 4 by the edges 13 of the inwardly-projecting plunged bosses of the drill element 4. In the invention, the first and second connection means 11 and 15 need to be selected so as to be capable of withstanding the rotation applied to the rivet 1 during drilling.

In the invention, the flats 9 on the second portion 6 of the body 2 also serve to prevent the drill element 4 from turning relative to the body 2 of the rivet 1 when the drill element 4 is fitted onto the body 2 of the rivet 1, thus making it possible for rotation exerted by a screw-driver tool on the body 2 of the rivet 1 to be transmitted to the drill element 4.

The rivet 1 is put into place through the two plates P and P′ in order to assemble them together by driving the rivet 1 in rotation in the conventional screw-driving direction as a result of the tool acting on the bushing 8, the tool passing through the collar 3 in order to make a hole through the two plates P and P′ and assemble them together as shown in FIG. 5.

When the collar 3 comes to bear against the upper plate P for assembling together, the second portion 6 of the body 2 is caused to rise towards the collar 3 by the tool applying traction on the thread of the bushing 8, thereby causing the expandable third portion 7 to deform radially. This radial deformation of the third portion 7 of the body 2 causes the flexible tabs to splay apart so that the ends 16 loose contact with the notches, thereby ejecting the drill element 4 from the body 2 of the rivet 1. This arrangement thus enables the drill element 4, containing the drilling residue, to be ejected simultaneously and axially in automatic manner from the body 2 by means of thrust generated by the deformation of the third portion 7 of the body 2 of the rivet 1.

When the third portion 7 is fully expanded, as shown in FIG. 5, the third portion 7 of the body 2 forms a bead 17 under the assembled-together plates P and P′. The bead 17 provides good tear-out strength and good shear strength. The rivet 1 is then anchored on both sides of the two plates P and P′.

In the invention, the abrasive outside surfaces of the flexible tabs of the drill element 4 serve to sand the inside of the hole in order to eliminate projecting fibers and/or locally delaminated zones.

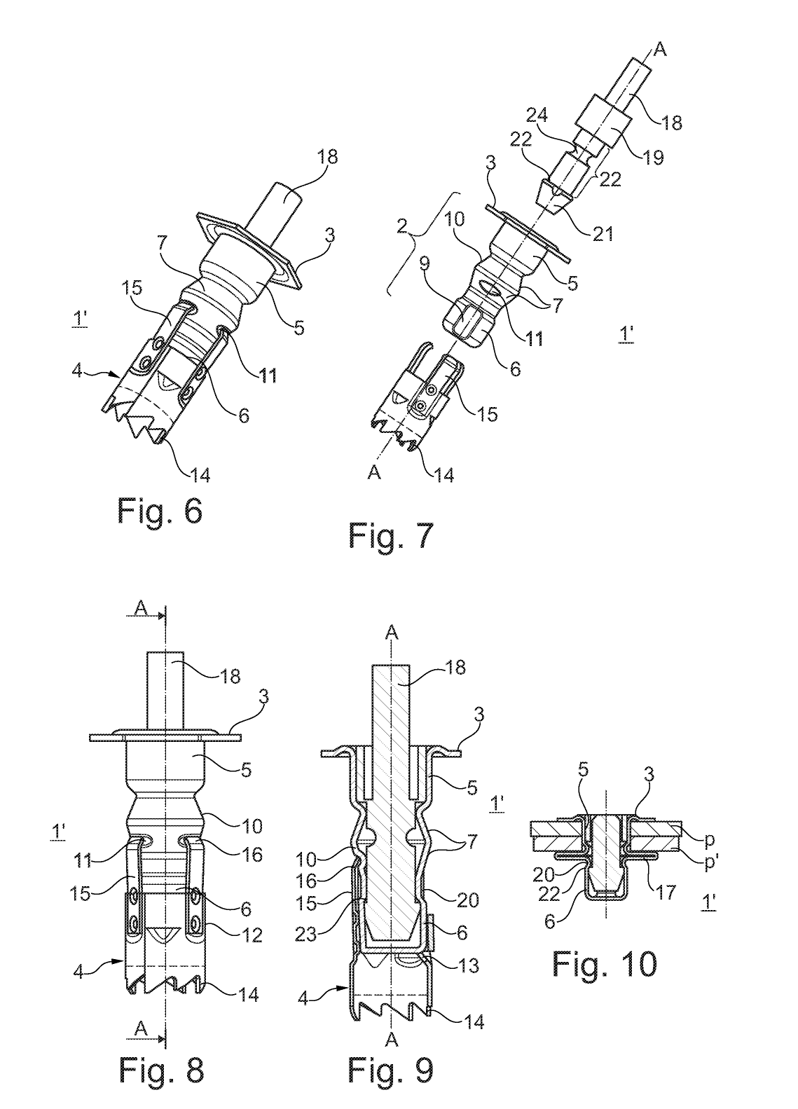

In a second embodiment of the invention, instead of having a bushing 8 in the rivet body 2 for co-operating with the screw-driver tool, it is possible to have a rod 18 arranged in the rivet body 2. This variant of the invention is shown in FIGS. 6 to 10.

Elements that are common to both embodiments are given the same references and are not described in detail again.

FIGS. 6 and 7 show a rivet 1′ of the second embodiment of the invention for assembling together two elements, specifically two plates (P and P′, as shown in FIG. 10).

The rivet 1′ has a hollow tubular body 2 in the form of a drum with a solid axial wall, the first, second, and third cylindrical portions 5, 6, and 7 extending along the axis AA, the collar 3, and the zone onto which the drill element 4 is engaged as a sliding fit, which drill element can be seen in isolation in exploded FIG. 7.

In the second embodiment, the rivet 1′ has a rod 18, which in this example is generally cylindrical as can be seen in isolated manner in FIG. 7.

The rod 18 for inserting in the body 2 of the rivet 1′ comprises three portions extending along the axis AA: a first portion 19 of the rod 18 for inserting into the first portion 5 of the body 2 of the rivet 1′ has a length so that it also projects beyond the collar 3 outside the body 2 of the rivet 1′; a second portion 21 of the rod 18 for being received in the second portion 6 of the body 2 of the rivet 1′; and a third portion 22 between the first and second portions 19 and 21 of the rod 18, which third portion 22 is received in the third portion 7 of the body 2 of the rivet 1′.

The portion of the first portion 19 of the rod 18 that projects relative to the rivet body 2 is used for driving the rivet 1′ in rotation in the conventional screw-driving direction, by means of the tool acting on this portion extending outside the body 2, and it also serves to apply axial traction.

The second portion 21 of the rod 18 in this example is bullet-shaped with a shoulder 23 that co-operates with the narrowing of section 20 in the second portion 6 of the body 2 forming the shoulder for preventing the rod 18 from moving axially in the body 2 of the rivet 1′. Second flats (not shown) of the body 2 formed on the inside surface of the second portion 6 of the rivet body 2 co-operate with the second portion 21 of the rod 18 to prevent the rod 18 turning relative to the body 2 of the rivet 1′. Thus, the body 2 and the rod 18 are constrained to rotate together about the axis.

The third portion 22 of the rod 18 in this example presents a zone of narrowing that corresponds to a zone 24 that is breakable under the effect of appropriate axial traction. The drill element 4 is fitted onto the cylindrical second portion 6 of the body 2 of the rivet 1′ in the same manner as described above.

In the second embodiment, the rivet 1′ is put into place in the two plates P and P′ in order to assemble them together by driving the rivet 1′ in rotation in the conventional screw- driving direction by using the tool acting on the rod 18, thereby making a hole through the two plates P, P′ and assembling them together as shown in FIG. 10.

As above, when the collar 3 comes to bear against the top plate P of the plates for assembling together, the second portion 6 of the body 2 is raised towards the collar 3 by the tool applying traction on the rod 18, thereby radially deforming the expandable third portion 7 and thus releasing the drill element 4 from the body 2 of the rivet 1′ by automatic ejection.

When the third portion 7 is fully expanded, as shown in FIG. 10, in addition to the presence of the bead 17 under the assembled-together plates P and P′, tear-out strength and shear strength are reinforced by the presence of a fraction of the third portion 22 of the rod 18 in the first portion 5 of the body 2 of the rivet 1′. The breakable zone 24 is arranged so that after the elements P and P′ have been assembled together, the rod 18 breaks in the breakable zone 24 so that the fraction of the rod 18 that remains inside the body 2 of the rivet 1′ does not extend out from the body 2 of the rivet 1′, with the fraction of the rod 18 that remains inside the body 2 of the rivet 1′ coming flush with the collar 3.

In this second embodiment, when the rivet 1′ is anchored against both sides of the two plates P and P′, the fraction of the rod 18 that remains inside the body 2 of the rivet 1′ serves to fill all of the expanded hollow body, thereby mechanically reinforcing the rivet and also sealing the assembly.

In the invention, the rivet 1, 1′ may be made of rolled and welded sheet metal, or out of die-stamped sheet metal.

The drill element 4 can thus be made out of rolled sheet metal with clinching by means of a dovetail, on welding, or crimping, or else it can be made out of die-stamped sheet metal.

The rivet 1, 1′ may also be made entirely by molding a plastics material or by injecting a plastics material so as to enable it to be fabricated at low cost and used for assembling together two car floor mats or a floor mat and a plate, for example.

Without being limiting, the rivet 1 could also be used for fastening wiring tunnels, for positioning heavy or lightweight fastening systems, or indeed for internal fastening in cars with metal or composite bodywork.

The rivet 1 could also be fabricated by additive manufacturing in a 3D printer, for example if only a short run is to be fabricated.

1. A self-drilling rivet comprising a bearing collar and an expandable hollow tubular body, said body having, at one end, a first cylindrical portion adjacent to said collar, and at the other end of said body, a second cylindrical portion arranged to receive a drill element, and between said cylindrical first and second portions, a third portion that is expandable, wherein said third portion of said body and said drill element have respective connection means that are arranged so as to separate said drill element from said body during expansion of said third portion of said body.

2. A self-drilling rivet according to claim 1, wherein said hollow tubular body presents a solid axial wall.

3. A self-drilling rivet according to claim 1, wherein said body presents an end wall on said cylindrical second portion.

4. A self-drilling rivet according to claim 1, wherein said cylindrical second portion has an inside thread.

5. A self-drilling rivet according to claim 4, wherein said expandable third portion is arranged to deform radially when said internally-threaded cylindrical second portion is driven in axial translation towards said collar by traction.

6. A self-drilling rivet according to claim 1, wherein said cylindrical second portion is arranged to receive a cylindrical rod extending axially in said body.

7. A self-drilling rivet according to claim 6, wherein said rod has, at one end, a first rod portion that extends in the first portion of the hollow body and that projects beyond said collar outside said body.

8. A self-drilling rivet according to claim 7, wherein said rod has, at its other end, a second rod portion arranged to be received in said second portion of said body, and wherein said second rod portion presents a shoulder for co-operating with a narrowing of section of said second portion of said body so as to be prevented from moving axially in said body.

9. A self-drilling rivet according to claim 8, wherein said expandable third portion of said body is arranged to deform radially when said first rod portion of said rod is driven in axial translation by traction.

10. A self-drilling rivet according to claim 8, wherein said rod has a third rod portion between the first and second rod portions and including a breakable zone, and wherein said third rod portion is arranged so that a fraction of said third rod portion is inserted in said first portion of said body when said third portion of said body is fully expanded radially.

11. A self-drilling rivet according to claim 10, wherein said fraction of said third rod portion is defined by said breakable zone arranged flush with said collar when said third portion of said body is fully expanded radially.

12. A self-drilling rivet according to claim 1, wherein said drill element is in the form of a hollow cylinder for being fitted via a first end on said cylindrical second portion of said body.

13. A self-drilling rivet according to claim 12, wherein said second portion of said body presents flats for preventing said drill element from turning relative to said body when said drill element is fitted on said body.

14. A self-drilling rivet according to claim 12, wherein said drill element presents at a second end a drill tool in the form of a crown saw.

15. A self-drilling rivet according to claim 14, wherein said hollow cylinder of said drill element presents edges projecting towards the inside of said hollow cylinder between said first end and said second end of said drill element in order to block the engagement of said hollow cylinder on said cylindrical second portion of said body.

16. A self-drilling rivet according to claim 12, wherein said drill element presents second connection means for connecting to said body.

17. A self-drilling rivet according to claim 16, wherein said second connection means for connecting said drill element to said body are in the form of flexible tabs extending axially beyond said first end.

18. A self-drilling rivet according to claim 17, wherein said flexible tabs of said drill element have outside surfaces that are abrasive.

19. A self-drilling rivet according to claim 16, wherein said expandable third portion of said body presents first connection means for connecting to said drill element.

20. A self-drilling rivet according to claim 19, wherein said first connection means for connecting said expandable third portion of said body with said drill element is in the form of notches arranged to receive said flexible tabs of said drill element.

21. A self-drilling rivet according to claim 1, wherein said self-drilling rivet is made of rolled and welded sheet metal.

22. A self-drilling rivet according to claim 1, wherein said self-drilling rivet is made of die-stamped sheet metal.
